(19) United States
(12) Patent Application Publication
(10) Pub. No.: US 2005/0106918 A1
(43) Pub. Date: May 19, 2005

(54) Modular connector

(76) Inventors: Robert G. Colantuono, Dover, PA (US); Ted R. Meckley, Seven Valleys, PA (US)

Correspondence Address: STEINBERG & RASKIN, P.C., 1140 AVENUE OF THE AMERICAS, 15th FLOOR, NEW YORK, NY, 10036-5803, US

(21) Appl. No.: 10/715,232

(22) Filed: Nov. 17, 2003

(51) Int. Cl. H01R 13/28

(52) U.S. Cl. 439/290

(57) ABSTRACT

Modular connector including a housing defining a cable-receiving cavity and having a lower wall, a tab at a front portion extending rearwardly and obliquely outward from the lower wall and an anti-snag member extending from the lower wall to engage with the tab to close a gap between the tab and the lower wall and prevent snagging of wires by the tab. The anti-snag member includes an arcuate portion defining a forward facing end at an interface between the arcuate portion and the lower wall. The connector also includes an arrangement for electrically coupling a cable when received in the cavity to electrical contacts in a mating connector. In the manufacturing process, the anti-snag member is formed as a part of the mold of the housing but in a planar form extending rearwardly from the lower wall and is then bent by heating into the arcuate form.

### FIELD OF THE INVENTION

The present invention relates to a modular connector, and in particular, to a modular plug having an anti-snag member which prevents a latch on the plug from snagging or catching on communication lines or other objects.

### BACKGROUND OF THE INVENTION

Modular connectors such as plugs are used to connect one computer to another via communication lines. In use, a modular plug is adapted to receive a cable at one end, while the other end of the modular plug is adapted to be inserted into a jack to establish an electrical connection between the wires in the cable received by the modular plug and contact elements in the jack.

One type of modular plug used widely in the network industry is an RJ-45 plug. An RJ 45 plug is used for data transmission lines, such as the ones used for Ethernet LAN and telephone wiring. A typical RJ-45 plug has a tab extending rearwardly and obliquely from its connecting end. The tab is spring-biased and serves to lock the plug in place when the plug is inserted into a jack. Removal of the plug from the jack requires depression of the tab to disengage the tab from a locking surface of the jack.

In use, most plugs are inserted into jacks located in central hubs, or switch locations that include patch panels or other telecommunications equipment having a multiplicity of relatively closely spaced modular jacks. The jacks are typically arranged relatively closely together. When a communication line is disconnected from the patch panel, its connector is first released from a corresponding jack, and the line is pulled out from among the other lines. Once the connector is released, the tab of the plug forms a hook-like configuration which points obliquely away from the body of the plug. As the communication line is being pulled out, its associated tab often catches or snags another line or other object, and this causes the line to become entangled. Frequently, in these situations, the tab breaks off due to the force exerted by the individual pulling the line.

Accordingly, while the conventional modular plug is a useful component that works quite well when the communication lines and jacks are spaced relatively far apart, it does have the above-described problem of the tendency to create snags when the lines and jacks are positioned in close proximity with one another.

There are disclosed in the prior art various methods of solving the afore-mentioned problem with standard modular plugs.

For example, U.S. Pat. No. 5,462,457 describes a modular connector that has an overmold partially covering a latch on an electrical connector to prevent snagging of the latch. The overmold is quite complicated to manufacture, requiring four dies and very exact dimensioning.

In addition, U.S. Pat. No. 5,613,869 describes a modular connector having a guard covering the free end of the tab to prevent the free end from catching another communication line or other object when the connector and its associated communication line are removed from the panel. The guard forms a recess below the lower surface of the housing of the connector to accommodate a free end of the tab.

Also, U.S. Pat. No. 5,993,236 describes a modular plug with a tab that includes a free end that extends downwardly toward a top wall of the connector to terminate in close proximity to the surface of the connector or extends into a depression in the surface of the connector to prevent snagging or tangling of the tab with other connectors or surfaces.

As described in detail below, the modular plug in accordance with the present invention solves the problem of snagging of tabs of modular plugs and provides advantages over prior art plugs, including those described above.

### OBJECTS AND SUMMARY OF THE INVENTION

It is an object of the present invention to provide a modular plug with a locking tab having a structure that prevents the free end of the locking tab of the plug from inadvertently catching on lines or other objects.

It is another object of the present invention to provide a modular plug that includes an anti-snag member that engages a free end of the locking tab of the plug to prevent the tab from becoming snagged or tangled when separated from a mating jack.

It is still another object of the present invention to provide a modular plug can be connected to and removed from a jack without snagging.

It is yet another object of the present invention to provide a new method for manufacturing a housing of a modular plug in which an anti-snag member can be formed during the molding process.

Accordingly, in order to achieve these objects and others, a modular connector in accordance with the invention includes a housing defining a cable-receiving cavity opening at a rear of the housing and comprising a lower wall, a tab at a front portion extending rearward and obliquely outward from the lower wall and an anti-snag member extending from the lower wall to overlie or engage with a free end of the tab to thereby close a gap between the tab and the lower wall and prevent snagging of wires and the like by the tab. The anti-snag member includes an arcuate portion defining a forward facing end at an interface between the arcuate portion and the lower wall. The connector also includes an arrangement for electrically coupling a cable when received in the cable-receiving cavity to electrical contacts in a mating connector, as well as possibly other conventional features of this type of a modular connector.

Additional features of the anti-snag member include the presence of an inner forwardly facing surface which is contiguous with an outer, planar surface of the lower wall. The planar surface of the lower wall extends further rearward than the tab such that inward flexing movement of the tab, i.e., during removal of the connector from a mating connector, is limited by the contact between the tab and the planar surface of the lower wall.

The arcuate portion of the anti-snag member is concave and is arranged to initially project rearward from the interface between the anti-snag member and the lower wall and outward from the lower wall and then forwardly toward the tab. A straight portion of the anti-snag member defines the free end of the tab and in view of the interposition of the arcuate portion between the straight portion and the lower wall, the straight portion begins at a distance from the lower wall and extends forwardly and usually obliquely relative to the lower wall.

The construction of the housing including the anti-snag member is accomplished by a novel manufacturing method in which a body of dielectric material is molded to include the cable-receiving cavity opening at the rear of the housing, the lower wall and the tab. The anti-snag member is not formed during the molding process with the arcuate portion. Rather, a straight, planar anti-snag member is formed extending rearwardly from the lower wall. This has the potential to enable an easier molding process than if the arcuate portion were to be formed during the molding process.

To provide the housing with its final form as described above, the planar anti-snag member is bent forward, e.g., upon the application of heat, until the anti-snag member overlies a free end of the tab and possibly engages the free end of the tab. During the bending of the planar anti-snag member, the arcuate portion is formed along with the straight portion having the form described above.

### BRIEF DESCRIPTION OF THE DRAWINGS

A more complete appreciation of the present invention and many of the attendant advantages thereof will be readily understood by reference to the following detailed description when taken in conjunction with the accompanying drawings, in which:

FIG. 1 is a rear, left perspective view of a modular plug according to the present invention in its final form showing the top, rear and left sides thereof;

FIG. 2 is a front, left perspective view of the modular plug shown in FIG. 1 showing the bottom, front and left sides thereof;

FIG. 3 is a longitudinal cross-sectional view of the modular plug shown in FIG. 1;

FIG. 4 is a rear, left perspective view of the modular plug according to the invention, in the “as molded” state, showing the top, rear and left sides thereof; and

FIG. 5 is a longitudinal cross-sectional view of the modular plug shown in FIG. 4.

### DETAILED DESCRIPTION OF THE INVENTION

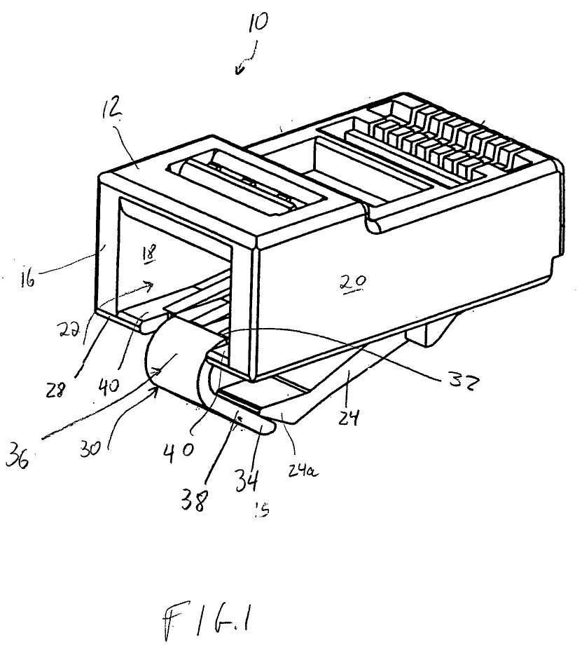

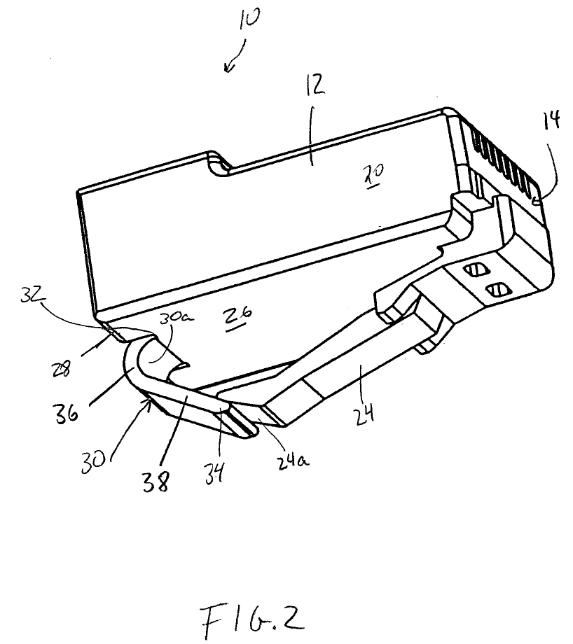

Referring to FIGS. 1-5 in which like reference characters designate identical or corresponding parts throughout the several views, the modular plug in accordance with the present invention in its final, operative form is identified generally by the reference numeral 10. Modular plug 10 includes a housing 12 having a front jack-mating end 14 and a rear cable-receiving end 16. The housing 12 includes opposed side walls 18,20 defining a longitudinal cable-receiving cavity 22.

Housing 12 also includes a cantilevered latch arm or tab 24 extending rearward and obliquely from the jack-mating end 14 of the housing 12. Tab 24 is designed to flex relative to a planar surface 26 of a lower wall 28 of the housing 12 and operatively engages with a cooperating mechanism on a mating jack to provide selective coupling of the plug 10 to the jack. That is, once the plug 10 is inserted into the jack, it can be detached therefrom by pressing the tab 24 toward the lower wall 28 while pulling the plug 10 away from the jack.

The housing 12 of the plug 10 may be made by any known manufacturing technique for producing housing of modular plugs including injection molding from a plastic or another dielectric material. In the conventional manner, housing 12 is adapted to receive a cable (not shown) in the cable-receiving cavity 22 via the cable-receiving end 16 so that wires of the cables are brought into electrical engagement with contact blades arranged in blade-receiving slots formed in the housing 12. The contact blades in turn are brought into electrical contact with electrical contacts in the mating jack when the plug 10 is mated with the jack. Other arrangements for establishing electrical contact between the wires of the cable and the contacts in the mating jack are also envisioned for the plug 10 in accordance with the invention.

The housing 12 also includes other features typical for modular plugs, some of which are shown in the drawings such as a strain relief element, but a description of these features is not essential to an understanding of the invention and will not be provided herein.

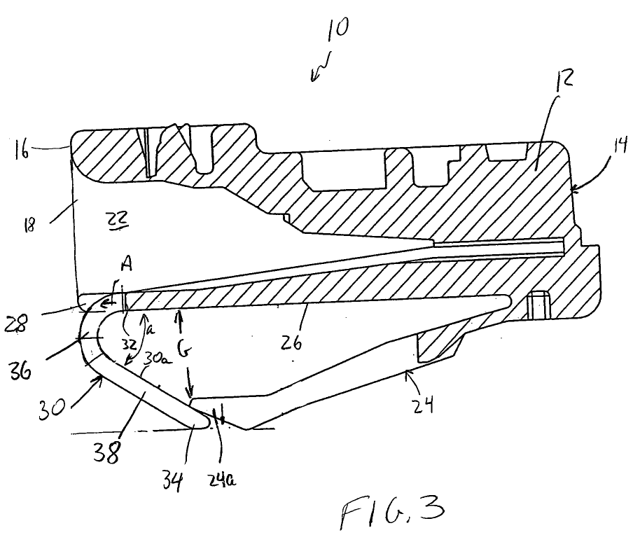

In conventional plugs, snagging of the tab 24 results when objects are caught in a gap G between a free end 24a of the tab 24 and the surface 26 of the lower wall 26 of the housing 12 (se FIG. 3).

In accordance with the invention however, the housing 12 includes an anti-snag mechanism which closes the gap G and thereby prevents objects from being caught therein. The anti-snag mechanism comprises an anti-snag or guard member 30 engaging with the free end 24a of the tab 24. Specifically, the anti-snag member 30 has a forward facing, housing engaging end 32 at an interface between the anti-snag member 30 and the lower wall 28 of the housing 12. An inner forward-facing surface 30a of the anti-snag member 30 is contiguous with the surface 26 of the lower wall 28 at the interface between the anti-snag member 30 and the lower wall 28. The anti-snag member 30 also has a free, tab engaging end 34 at which the anti-snag member 30 overlies and preferably engages with the free end 24a of the tab 24.

Guard member 30 includes an arcuate portion 36 which is contiguous with the lower wall 28 and defines the forward facing, housing engaging end 32. Arcuate portion 36 curves outward relative to the lower wall 28. The curvature of the arcuate portion 36 is concave so that the arcuate portion 36 initially projects rearward from the lower wall 28 (in the direction of arrow A at and adjacent the housing engaging end 32), and then slightly in a forward direction. A straight portion 38 of the anti-snag member 30 defines the tab engaging end 34. The straight portion 38 extends forwardly and obliquely relative to the lower wall 28 toward the free end 24a of the tab 24. An angle “a” defined between the inner surface of the straight portion 38 of the anti-snag member 30 and the surface 28 of the lower wall 26 of the housing 12 is about 33° (see FIG. 3).

The anti-snag member 30 extends only across a portion of the entire width of the lower wall 28 so that a portion of the arcuate portion 36 is alongside a straight portion of the lower wall 28 (see FIGS. 1 and 3). As shown, the anti-snag member 30 is centered on the lower wall 28 of the housing 12 adjacent the cavity 22 so that shoulders 40 of the lower wall 28 are formed defining the cavity 22, one shoulder 40 on each side of the arcuate portion 36 of the anti-snag member 30. The width of anti-snag member 30 in its entirety, i.e., including the arcuate portion 36 and the straight portion 38, may be uniform as shown or can vary if desired.

In view of the presence of the anti-snag member 30 overlying the tab 24, the gap G between the free end 24a of the tab 24 and the lower wall 28 of the housing 12 is closed. In addition, outward movement of tab 24 relative to the lower wall 28 is limited in view of the engagement of the free end 34 of the anti-snag member 30 with the free end 24a of the tab 24.

A significant advantage of the invention arises from the fact that the anti-snag member 30 may be formed in the same molding process with the remaining portion of the housing 12.

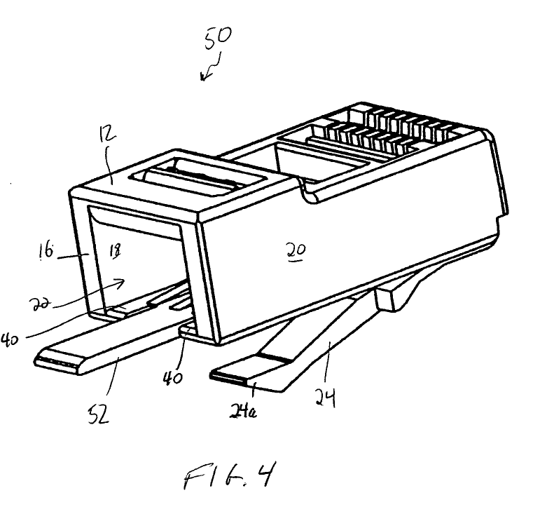

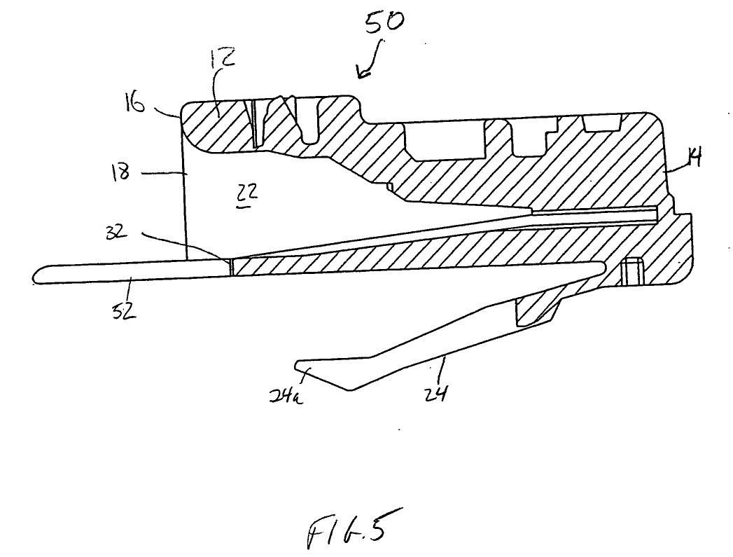

Referring now to FIGS. 4 and 5 wherein the plug in its molded state is generally designated 50, in an exemplifying molding process in which the housing 12 is molded as a body of dielectric material, in the molded state of the plug 52, the anti-snag member 52 is formed as a planar portion extending straight and rearward from the lower wall 28 of the housing 12. The planar anti-snag member 52 is also formed to have a contiguous outer surface with the lower wall 28. After molding is completed, the planar anti-snag member 52 is bent into the final form with the free, tab engaging end 34 of the anti-snag member overlying and preferably engaging with the free end 24a of the tab 24.

Bending of the planar anti-snag member 52 may involve heating the anti-snag member, for example by a soldering iron, and while heated, the anti-snag member 52 is shaped into the final form of the anti-snag member 30 shown in FIGS. 1-3 with the arcuate portion 36 and straight portion 38.

Although exemplary embodiments of the present invention has been shown and described, it will be apparent to those having ordinary skill in the art that a number of changes, modifications or alterations may be made, none of which depart from the spirit of the present invention.

1. A modular connector, comprising:
a housing defining a cable-receiving cavity opening at a rear of the housing, said housing comprising:
a lower wall defining a side of said cavity,
a tab at a front portion extending rearward and obliquely outward from said lower wall, and
an anti-snag member having an arcuate portion having a forward facing end at an interface between said arcuate portion and said lower wall and a free end overlying said tab to thereby close a gap between said tab and said lower wall;
an arrangement for electrically coupling a cable when received in said cable-receiving cavity to electrical contacts in a mating connector.

2. The connector of claim 1, wherein said anti-snag member includes an inner, forwardly facing surface contiguous with an outer surface of said lower wall.

3. The connector of claim 2, wherein said outer surface of said lower wall is planar.

4. The connector of claim 1, wherein said free end of said anti-snag member engages a free end of said tab.

5. The connector of claim 1, wherein said arcuate portion is concave.

6. The connector of claim 1, wherein said arcuate portion is arranged to initially project rearward from said interface between said anti-snag member and said lower wall and outward from said lower wall and then forwardly toward said tab.

7. The connector of claim 1, wherein said anti-snag member further includes a straight portion defining said free end, said straight portion beginning at a distance from said lower wall and extending forwardly and obliquely relative to said lower wall.

8. The connector of claim 1, wherein said anti-snag member extends only across a portion of the entire width of said lower wall.

9. The connector of claim 1, wherein said anti-snag member is centered on said lower wall.

10. The connector of claim 1, wherein said arcuate portion of said anti-snag member faces said cavity.

11. The connector of claim 1, wherein said anti-snag member has a uniform width.

12. A modular connector, comprising:
a housing defining a cable-receiving cavity opening at a rear of the housing, said housing comprising:
a lower wall having a planar outer surface and defining a side of said cavity,
a tab at a front portion extending rearward and obliquely outward from said lower wall, said planar surface of said lower wall extending further rearward than said tab such that such that inward, flexing movement of said tab is limited by contact between said tab and said planar surface of said lower wall, and
an anti-snag member projecting from said lower wall such that an inner, forwardly-facing surface of said anti-snag member is contiguous with said planar surface of said lower wall, said anti-snag member having a free end overlying said tab to thereby close a gap between said tab and said lower wall; and
an arrangement for electrically coupling a cable when received in said cable-receiving cavity to electrical contacts in a mating connector.

13. The connector of claim 12, wherein said anti-snag member has an arcuate portion defining a forward facing end at an interface between said arcuate portion and said lower wall, said arcuate portion being arranged to initially project rearward from said interface between said anti-snag member and said lower wall and outward from said lower wall and then forwardly toward said tab.

14. A method for forming a housing of modular connector with an anti-snag mechanism, comprising the steps of:
molding a body of dielectric material to include a cable-receiving cavity opening at a rear of the housing, a lower wall, a tab at a front portion extending rearward and obliquely outward from the lower wall, and a planar anti-snag member extending rearwardly from said lower wall; and
bending the anti-snag member forward until the anti-snag member overlies a free end of the tab.

15. The method of claim 14, wherein the step of bending the anti-snag member forward comprises the step of heating the anti-snag member.

16. The method of claim 14, wherein the anti-snag member is bent forward until the anti-snag member engages the free end of the tab.

17. The method of claim 14, wherein the anti-snag member is bent forward to form an arcuate portion defining a forward facing end at an interface between the arcuate portion and the lower wall.

18. The method of claim 17, wherein the anti-snag member is bent forward to form a straight portion adjacent the arcuate portion and defining a free end of the anti-snag member, the straight portion beginning at a distance from the lower wall and extending forwardly and obliquely relative to the lower wall.

19. The method of claim 14, wherein the body of dielectric material is molded such that the anti-snag member includes an inner, forwardly facing surface contiguous with an outer surface of the lower wall.

20. The method of claim 14, wherein the body of dielectric material is molded such that the anti-snag member extends only across a portion of the entire width of the lower wall.
